(19) United States
(12) Patent Application Publication
(10) Pub. No.: US 2012/0323647 A1
(43) Pub. Date: Dec. 20, 2012

(54) ANALYZING CONSUMER BEHAVIOR INVOLVING USE OF SOCIAL NETWORKING BENEFITS ASSOCIATED WITH CONTENT

(76) Inventor: Scott Klooster, Duvall, WA (US)

(21) Appl. No.: 13/598,592

(22) Filed: Aug. 29, 2012

Related U.S. Application Data
(63) Continuation-in-part of application No. 13/457,382, filed on Apr. 26, 2012.
(60) Provisional application No. 61/664,508, filed on Jun. 26, 2012.

(51) Int. Cl. G06Q 30/02

(52) U.S. Cl. 705/14.1

(57) ABSTRACT

Social networking users are rewarded with points for creating content or commenting on the content of other social networking users. The rewards engine may be a part of a social networking site, or may be a stand-alone system which may be used by social networking sites to offer rewards to users. Upon receiving an event including a user and event type, the system determines a point value, instantly and/or in the future. Different point values may be assigned to different event types, or points may be awarded based upon the measured impact over time, or points may be awarded according to user votes. Points may be awarded for enrolling, making new friends, creating content, commenting on content, among other event types. Points may be revoked for deleting content or blocking users, among other event types. A hierarchy of point values may assign fewer or greater points to particular event types.

### PRIORITY CLAIM

This application is a continuation-in-part of prior application Ser. No. 13/457,382 filed Apr. 26, 2012 and claims priority from provisional application No. 61/664,508 filed Jun. 26, 2012. The foregoing applications are hereby incorporated by reference in their entirety as if fully set forth herein.

### FIELD OF THE INVENTION

This invention relates generally to analyzing consumer behavior, and more specifically, to systems and methods for analyzing consumer behavior involving use of social networking benefits associated with content.

### BACKGROUND

Conferring points on social network users provides new opportunities and benefits in connection with rewards for social network users for activities related to content, and other types of activities. Further opportunities exist for analyzing consumer behavior using social points, rewards and customer data.

### SUMMARY

Method and system embodiments involving implementation of rewards for social network users for content as disclosed herein may take different forms. For example, one or more computer program products having non-transitory computer readable media for encoding process instructions may be incorporated in a computerized system.

An exemplary system and/or method for rewarding social networking users may include receiving an event information, the event information indicative of a social networking user and a social networking event type; and conferring the social networking user with a point value, the point value associated with the social networking event type. Other possible system and/or method features may include receiving an event information from a social networking system; receiving an event information from a social networking system that is external; receiving event information indicative of at least one of a user event type or a content event type; receiving event information indicative of a user event type, the user event type comprising one or more of signing up for the social network, adding another social network user to a friends list or blocking another social network user; and/or receiving event information indicative of a content event type, the content event type comprising one or more of posting an image, posting a status update, writing on a wall of another social network user, commenting on content posted by another social network user, or deleting content previously posted.

Additional possible system and/or method features may include conferring the social networking user with a point value, the point value determined by a point value determinator component; conferring the social networking user with a point value determined by an point value determinator component immediately upon receiving an event information; conferring the social networking user with a point value determined by an point value determinator component at a future time after receiving an event information; conferring the social networking user with a point value determined by an point value determinator component according to a hierarchy; conferring the social networking user with a point value determined by an point value determinator component according to a measured impact; conferring the social networking user with a point value determined by an point value determinator component according to an estimated impact; conferring the social networking user with a point value determined by an point value determinator component according to voting by other social networking users; conferring the social networking user with a point value determined by an point value determinator component according to activity by other social networking users; conferring the social networking user with a negative point value and/or conferring the social networking user with a negative point value for one or more of deleting content previously posted or blocking another social network user.

Additional possible system and/or method features may include accumulating the point value for the social networking user as a point total; and/or facilitating redemption from the point total of the social networking user for at least a benefit to the social networking user.

In addition to the foregoing, various other methods, systems and/or program product embodiments are set forth and described in the teachings such as the text (e.g., claims, drawings and/or the detailed description) and/or drawings of the present disclosure.

The foregoing is a summary and thus contains, by necessity, simplifications, generalizations and omissions of detail; consequently, those skilled in the art will appreciate that the summary is illustrative only and is NOT intended to be in any way limiting. Other aspects, embodiments, features and advantages of the device and/or processes and/or other subject matter described herein will become apparent in the teachings set forth herein.

### BRIEF DESCRIPTION OF THE DRAWINGS

Certain embodiments of the present invention are described in detail below with reference to the following drawings:

FIGS. 1 and 2 depict exemplary environments in which the methods and systems described herein may be represented;

FIG. 3 depicts a high-level logic flowchart of an operational process;

FIGS. 4-8 depict several alternative implementations of the operational process of FIG. 3;

FIG. 9 illustrates a partial view of an exemplary computer program product; and

FIG. 10 presents a block diagram of an exemplary environment in which the methods and systems described herein may operate.

### DETAILED DESCRIPTION

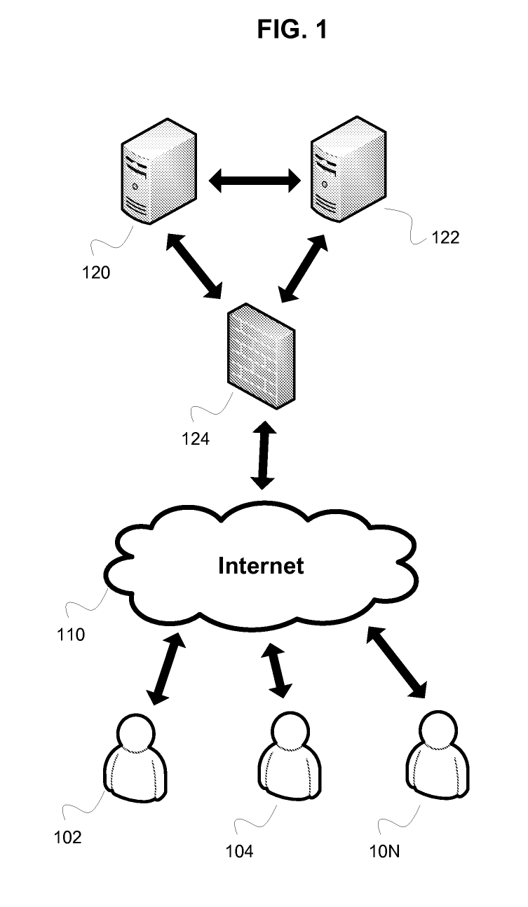

This invention relates generally to social networking, and more specifically, to systems and methods for rewarding social network users for content. Specific details of certain embodiments of the invention are set forth in the following description and in FIGS. 1-10 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 depicts an exemplary environment 100 in which the methods and systems described herein may be represented. In the exemplary environment 100, one or more social networking users are depicted. There may be a large number of social networking users, including a first social networking user 102, a second social networking user 104, all the way through an n-th social networking user 10N. The social networking users interact with a social networking system via the Internet 110. The social networking users gain access to the social networking system using a computing device. In some embodiments, a computing device is a personal computer. In other embodiments, a computing device is a smartphone. In different embodiments, a computing device is a laptop, netbook, tablet, or any other device enabling a user to access web content over the Internet. In still other embodiments, a computing device enabling a user to access web content may be a video game console, an appliance with an Internet browser built in, or any other device or system connected to the Internet which may be utilized by a user to access content located on the Internet.

In some embodiments of the invention, the social networking users connect to a social network, the social network represented in FIG. 1 by the system 120. The social network 120 may be comprised of one or more software components that are implemented on a single host system, or are dispersed among multiple servers in a server farm. The social network may, for example, be made up of front-end web servers, database servers, index servers, identity management servers, load balancers, or other components. The components may be located in a single data center, may be spread across multiple data centers in multiple locations, may be run in virtual machines, and/or may have redundant systems. Indeed, many combinations of server architecture, software components and physical locations are possible, and all are represented logically in FIG. 1 by the social network server 120.

In some embodiments of the invention, the social network 120 is operably connected to a rewards server 122. Like the social network 120, the rewards server may be comprised of one or more software components that are implemented on a single host system, or can be dispersed among multiple servers in a server farm. The rewards server may have any combination of server architecture, software components and physical locations as previously described relative to the social network, and all such combinations are represented logically in FIG. 1 by the rewards server 122.

In some embodiments of the invention, the social network 120 and the rewards server 122 are located on the same logical network. The logical network may be coupled with the Internet at a firewall 124. In some embodiments, the firewall 124 is a bastion host. In other embodiments, the firewall 124 is a proxy server. In different embodiments, the firewall 124 is a plurality of load-balancing network appliances. The firewall 124 may be a plurality of network ingress points which are implemented on firewalls throughout a plurality of data centers across geographically dispersed locations. Many combinations of network configurations are possible, and all such combinations are represented logically in FIG. 1 by the firewall 124.

Importantly, in FIG. 1, what is depicted is a social network 120 and a rewards server 122 that are operated by a single entity, wherein the social network and rewards server are on the same logical network and communicate with the Internet via the same logical egress point (i.e. the firewall 124).

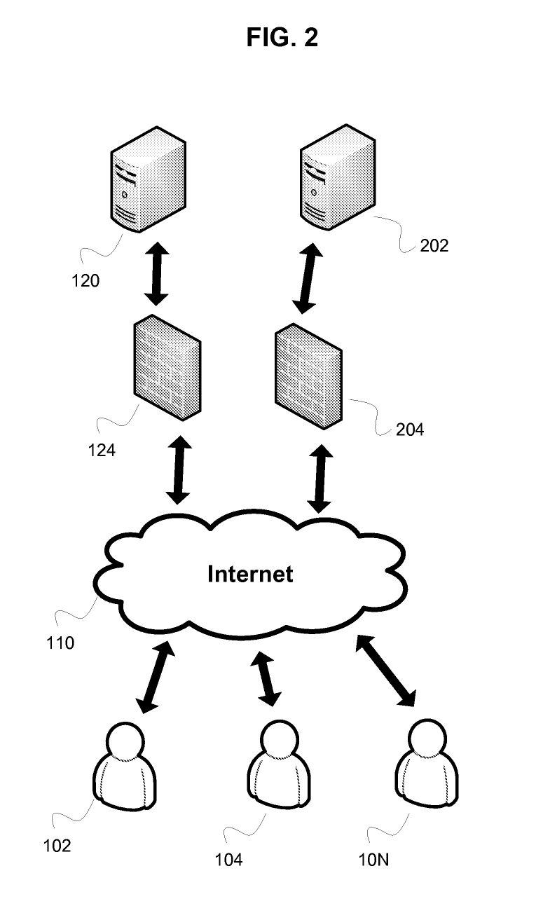

Turning to FIG. 2, the foregoing discussion related to the users 102, 104 and 10N; the Internet 110; the social network 120 and the firewall 124 similarly applies. Differently, in FIG. 2, the rewards server 202 is depicted as being on a different logical network from the social network, the different logical network being coupled to the Internet via the second firewall 204. The rewards server 202 may still be implemented using any combination of server architecture, software components and physical locations as disclosed in the foregoing discussion of the rewards server 122. Additionally, just as with the firewall 124, the second firewall 204 may be implemented with a single network device, a plurality of network devices in a single location, or a plurality of network devices in a plurality of locations forming a single logical network, and all such possible configurations are represented by the second firewall 204.

In some embodiments, the rewards server 202 may be on a different logical network from the social network 120. This may be because the rewards server and social network are run by the same entity in geographically dispersed locations. Or, it may be that the social network and rewards server are operated by different entities, where the operator of the social network has engaged with the operator of the rewards server to provide rewards management services for the plurality of users of the social network.

In some embodiments, rewards management services are configured as an API. In different embodiments, rewards management services are provided with SOAP. In still other embodiments, rewards management services are configured through a transfer or exchange of XML data files, or with AJAX, ASP, ASP.NET, UDDI, or WSDL. In yet a different embodiment, rewards management services are provided to a social network using any web service protocol or platform-independent server communications methodology.

In some embodiments, a social network may be an online community service, such as Facebook, Google+, MySpace, Twitter, Friendster, Classmates.com, or LinkedIn, among other examples. A user of such a site may create a user profile, account, login, credentials, or other means of authenticating the user to the site. In different embodiments, a social network may be a website that uses the authentication system of an online community service to authenticate users to its own site. For example, a social network may be any site that permits users to log into the site using the user's Facebook credentials, including (but not limited to) a newspaper site that permits users to post comments, the comments being identified by the user's Facebook profile information. In different embodiments, a social network may be a search engine, which permits users to log into the site using the credentials of an online community service, where the online community service may or may not be affiliated with the search engine site. In another non-limiting example, a social network may be a search engine such as Google, where a user may log into Google using the user's Google+ credentials. In yet another non-limiting example, a social network may be any site for which a user may create a user profile, account, login, credentials, or other means of authenticating the user to the site irrespective of whether users have a view of other users' activity.

In different embodiments, a social network may be an online forum, bulletin board, web portal, Internet forum, message board, discussion site, search engine, newsgroup, mailing list, blog host, moderated site, unmoderated site, email system, chat room, aggregator, network news site, virtual community, virtual world, content management system, or any other online site where users may create, modify, view or comment upon content or perform any other social networking activity.

In some embodiments, a social networking user may be a visitor to a social network, where the user may or may not create an account, user profile, login credentials, or other means of identifying the social networking user to the social network. In some embodiments, usage is anonymous and tracking and/or rewarding may be associated with the social networking user's source IP address, company, ISP, geographic location, browser software, or other means of corroborating usage with an identity.

In some embodiments, a social networking user may perform some activity associated with the social network. A social networking user may perform activities such as creating, modifying or deleting a profile for the social network. Within the context of social networking activity, a user may add, modify or delete content to the profile, including photos, multimedia content, notes, status updates, personal and/or demographic information, messages to others, links to other content, modules, applications, applets, and/or blog entries. A user may perform other activities relative to the social network. Such activities might include adding or deleting other users to/from a friends list; chatting with other users; sending tweets; messaging other users; commenting on other users posts; sending email to other users; searching for other users; entering a chat room; creating, modifying or deleting a thread; creating galleries, folders or other means of organizing content; writing on a wall; modifying the look and feel of a profile; applying a skin to a profile; uploading and/or downloading to/from the social network; sharing content and/or links; changing privacy settings; broadcasting content; consuming broadcasted content; checking-in; streaming; tagging; geotagging; joining a group; liking a page, user, company, or other entity; making a purchase; offering an item for sale; or any other online activity which may or may not be characterized as social networking activity.

In some embodiments, a social networking user may interact with the social network via a user interface. In some embodiments, the user interface may be implemented as a web page. In different embodiments, the user interface may be implemented as an applet or application. In other embodiments, the user interface may be a graphical user interface, interactive voice response system, command-line interface, touch-screen interface, display interface, gesture interface, object-oriented interface, natural language interface, or any other means through which a user may interact with a social network. In some embodiments, a user interface may include a newsfeed, a wall, a thread list, a discussion forum, one or more templates, an image gallery, a multimedia gallery, a profile listing, a user listing, a directory, a control panel, a windowing system, one or more frames, a desktop environment, a chat room, a list of topics, a plurality of search results, a public message, a private message, a wiki, a blogroll, or any other social networking user interface.

In some embodiments, a social network may be a free social network, in that there is no cost to create a profile and participate. In different embodiments, a social network may be a paid site, in that there may be a subscription or membership fee (periodic or lifetime) paid by a user in exchange for participating. In different embodiments, participation in a social network may be in exchange for a user creating content or conducting other social networking activity. In other embodiments, a user may participate in a social network in exchange for any form of compensation.

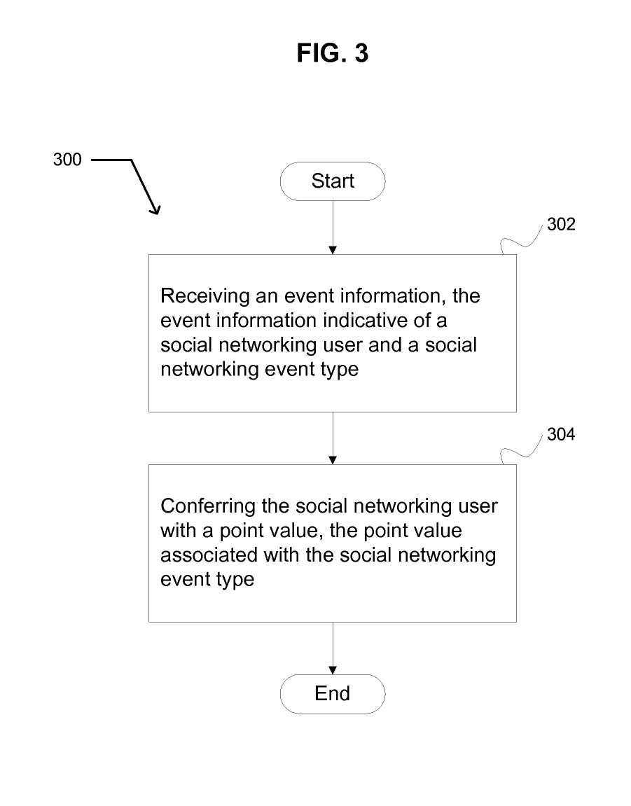

In FIG. 3 and in following Figures that include various examples of operational flows, discussion and explanation may be provided with respect to the above-described examples of FIGS. 1 and 2, and/or with respect to other examples and contexts. However, it should be understood that the operational flows may be executed in a number of other environments and contexts, and/or in modified versions of FIGS. 1 and 2. Also, although the various operational flows are presented in the sequence(s) illustrated, it should be understood that the various operations may be performed in other orders than those which are illustrated, or may be performed concurrently.

FIG. 3 depicts a high-level logic flowchart of an operational process, in accordance with an embodiment of the invention. After a start operation, the operational flow 300 moves to a receiving operation 302 where an event information is received, the event information indicative of a social networking user and a social networking event type. At a conferring operation 304, the social networking user is conferred with a point value, the point value associated with the social networking event type. The operational flow 300 then moves to an end operation.

In an exemplary, non-limiting embodiment, a rewards server 202 as depicted in FIG. 2 may confer point values for social networking users 102, 104 and 10N when the users conduct a social networking activity on the social network server 120. The rewards server 202 may receive information about which social networking user conducted the social networking activity (the information about the social networking activity encapsulated in a “social networking event type”) from the social network 120. Responsive to the receiving information, the rewards server may confer the social networking user with a point value, the point value associated with the social networking event type. As a non-limiting example, the rewards server may confer ten points on a social networking user who has created a social networking profile.

In the context of the present invention, “points” refers to an amount credited to, debited from, or otherwise maintained relative to a social networking user, where the amount is maintained by the rewards server. As used herein, the word “points,” and the terms “point value” and “point total,” do not require any particular usage or context for the point, point values and/or point totals. In different embodiments, the system may confer other units to social networking users for various social networking events, where the units could include credits, dollars, pennies, tokens, or any other word that refers to an enumerated value that may be incremented, decremented, maintained or otherwise operated upon. As will be disclosed, in some embodiments of the invention, the “point values” are accumulated as a “point total,” wherein a portion of the point total may be redeemed for a benefit to the social networking user. However, the instant disclosure is intended to be non-limiting as far as the terms “point value,” “point total,” and “points.” Any synonymous terms consistent with the meaning disclosed herein are within the context of the instant application.

In a different, exemplary and non-limiting embodiment, the rewards server 122 as depicted in FIG. 1 may confer point values for social networking users 102, 104 and 10N when the users conduct a social networking activity on the social network server 120. As discussed elsewhere herein, the rewards server may be operated by the same entity as the operator of the social network, wherein the rewards server may be a separate logical server from the logical social network server, or may be collocated with the social network server. Or, as discussed within the context of the first exemplary embodiment of operational flow 300, the rewards server may be operated by a different entity from the operator of the social network as explained elsewhere herein. Throughout the remainder of the instant application, it will be understood that the operational flow relating to conferring points may take place on a system and/or logical network and/or entity either internal or external to that of the social network, and that exemplary operations discussed with reference to FIG. 1 may equally apply with respect to FIG. 2.

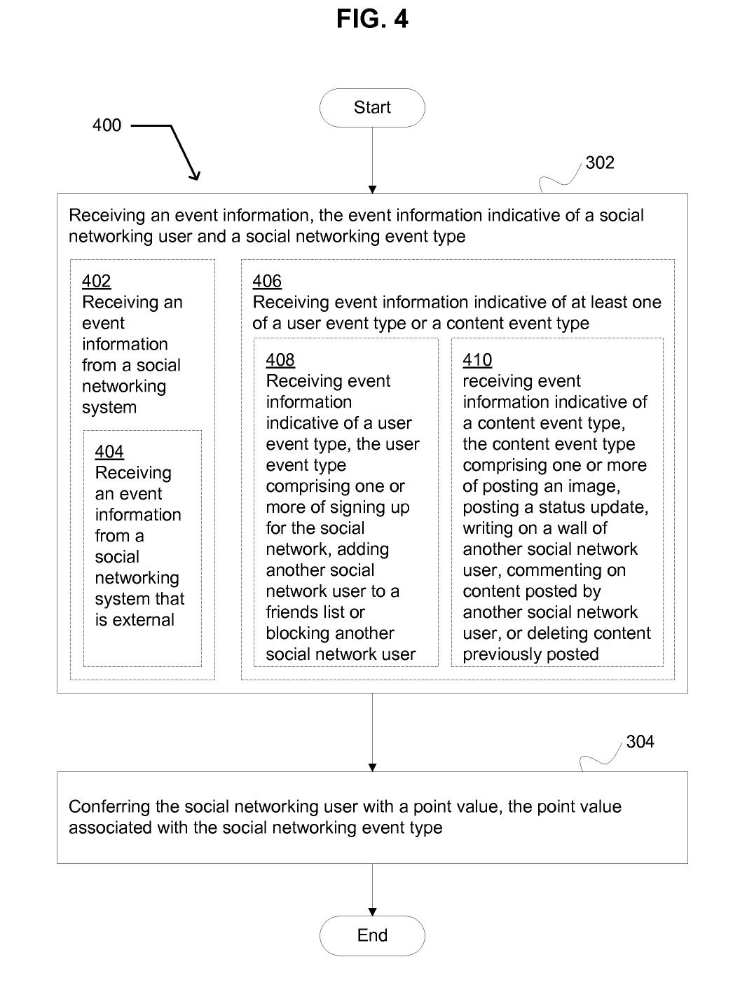

FIG. 4 illustrates alternative embodiments of the example operational flow 300 of FIG. 3. FIG. 4 illustrates example embodiments where the receiving operation 302 may include at least one additional operation. Additional operations may include operation 402, operation 404, operation 406, operation 408 and/or operation 410.

At the operation 402, event information is received from a social networking system. For example, a rewards server 122 may receive information indicative of a social networking user and a social networking event type from a social networking server. The information may include, for example, an indication from a particular social network 120 that social networking user 100 created a profile for the social network. As previously discussed elsewhere herein, receiving information from a social network may include receiving information from an online community service, a search engine, a newspaper site, an email host, or any other site in which a user's social networking credentials are associated with an activity the social networking user performs on that site. A user may, for example, leave a comment on a newspaper article at an online newspaper site in which comments are enabled using site visitors' social networking credentials, where the social networking credentials were established for an online community site that is different from the online newspaper site. Further refining the example, the rewards server may receive an event information including information that a Facebook user left a comment on a news article hosted by the seattlepi.com site, the comment being associated with the Facebook user's Facebook credentials.

In particular, in an example operation 404 that may be performed in addition to, or in association with, operation 402, the event information may be received from a social networking system that is external. As previously discussed elsewhere herein, the rewards server 202 may be operated by a third party, the third party providing rewards services to the social networking service, although the rewards server may be operated by the same operator as the social networking service.

At the operation 406, event information is received indicative of at least one of a user event type or a content event type. For example, the event information may include data indicative that a social networking user performed some action relative to the user's profile. In particular, in an example operation 408 that may be performed in addition to, or in association with, operation 406, the event information may include event information indicative of a social networking user 100 signing up for the social network, adding another social network user to a friends list, or blocking another social network user. Of course, it will be understood that a variety of social networking user events exist, with a partial listing of such events being included elsewhere herein, and that any such social networking user event that is received is represented within the context of the instant disclosure.

Also, in particular, in an example operation 410 that may be performed in addition to, or in association with, operation 406, the event information may include event information indicative of a social networking user 100 posting an image, posting a status update, writing on a wall of another social network user, commenting on content posted by another social network user, or deleting content previously posted. It will be understood that a variety of social networking content events exist, with a partial listing of such events being included elsewhere herein, and that any such social networking content event that is received is represented within the context of the instant disclosure.

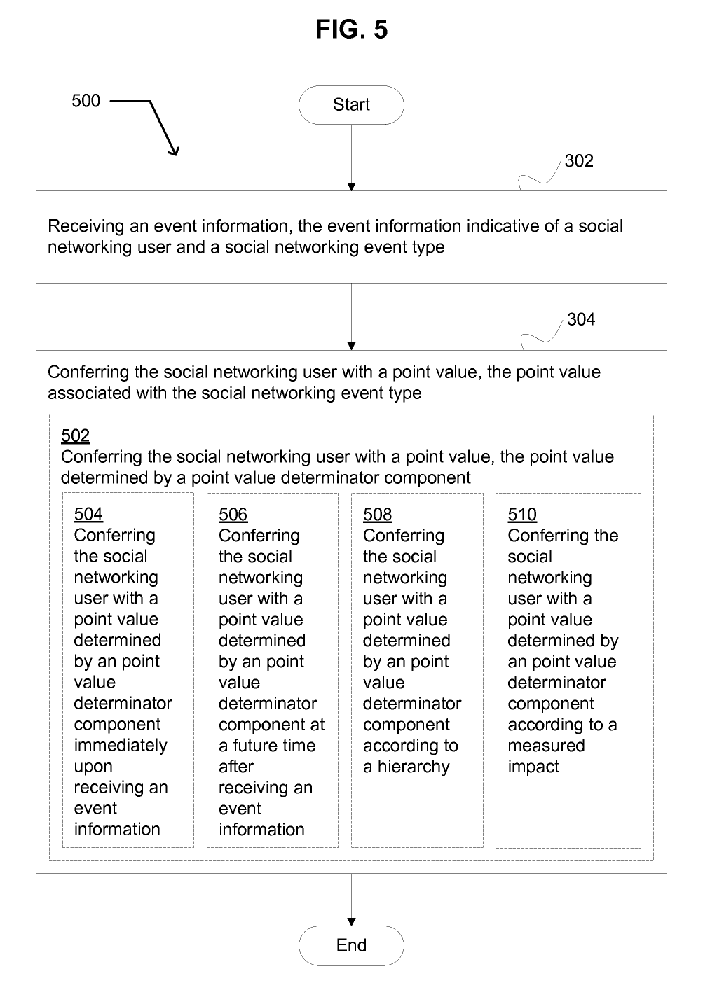

FIG. 5 illustrates alternative embodiments of the example operational flow 300 of FIG. 3. FIG. 5 illustrates example embodiments where the conferring operation 304 may include at least one additional operation. Additional operations may include operation 502, operation 504, operation 506, operation 508 and/or operation 510.

At the operation 502, the social networking user is conferred with a point value, the point value determined by a point value determinator component. For example, a point value determinator component may examine the social networking user and social networking event type and determine a point value to confer upon the social networking user. Some point values may be positive point values, and some point values may be negative point values. A point value determinator component may be one or more of a program, a lookup table, a stored procedure, a trigger, a subroutine, a module, a component, a piece of software, a service, an engine, a server, a device, a class library, a method, a function, and/or a different structure capable of and suited for implementation of a point value determinator component. The point value determinator component may be collocated with or separate from the rewards server 122, the social network 120, or be located at any other appropriate and suitable point in the logical configuration of the social network and rewards server.

In particular, in an example operation 504 that may be performed in addition to, or in association with, operation 502, the social networking user is conferred with a point value determined by a point value determinator component immediately upon receiving an event information. For example, the point value may be immediately determined upon receiving an event information indicative that social networking user 100 created a user profile on the social networking site 120.

Alternatively, in an example operation 506 that may be performed in addition to, or in association with, operation 502, the social networking user is conferred with a point value determined by a point value determinator component at a future time after receiving an event information. For example, when receiving an event information indicative that social networking user 100 uploaded a picture to the social networking site 120, the point value determinator may confer the social networking user with a point value a year after the picture has been uploaded.

Alternatively, in an example operation 508 that may be performed in addition to, or in association with, operation 502, the social networking user is conferred with a point value determined by a point value determinator component according to a hierarchy. For example, when receiving an event information indicative of social networking user 100 performing a social networking activity, the point value determinator component may determine a point value based upon a hierarchy of point values assigned to social networking events and/or user types. The hierarchy may include creating a social networking profile associated with 10 points, uploading a picture associated with 15 points, completing the social networking profile associated with 25 points, becoming an elevated type of user (for example, a user who has posted 500 or more times) associated with 30 points, and/or blocking another user being associated with −5 points. The point values may be constant for all users, or may have “accelerators” established by which users who conduct more activity receive bonus points for conducting additional activity, where, for example, a new user creating a post is associated with 10 points but an elevated user creating a post is associated with 20 points. In different embodiments, the point value hierarchy associates negative point values for affirmative activities such as uploading content and positive point values for negative activities such as removing content. In other embodiments, the point value hierarchy associates fractions of points for various activities. In different embodiments, the point value hierarchy associates points maintained in a different number base, such as a binary, octal or hexadecimal numbering system. In yet another embodiments, the point value hierarchy associates points according to a percentage, a set of point values, a vector and a magnitude, a real number and an imaginary number, or any other means of associating one or more enumerated values with an activity.

Alternatively, in an example operation 510 that may be performed in addition to, or in association with, operation 502, the social networking user is conferred with a point value determined by a point value determinator component according to a measured impact. For example, when receiving an event information indicative of social networking user 100 performing a social networking activity, the point value determinator component may determine a point value based upon an impact of the activity that is measured. The determined impact of a post created by a user may include a particular number of users commenting on the created post. Say, for example, user 100 creates a social networking post. If 3 users subsequently comment on the social networking post, the post may be associated with 10 points, but if 30 users subsequently comment on the social networking post, the post may be associated with 100 points. Or, if user 100 has 5 followers and user 102 has 50 followers, when user 100 comments on a post, the comment may be associated with 10 points, but if user 102 comments on the post, the comment may be associated with 100 points. In some embodiments, the point value determinator component may measure the impact. In different embodiments, the point value determinator component may receive a measured impact from a separate impact-measurement component, the separate impact-measurement component being operated either by the same operator, or by a third party such as Google Analytics, alexa.com or any other provider of traffic information, popularity, impact or other metrics.

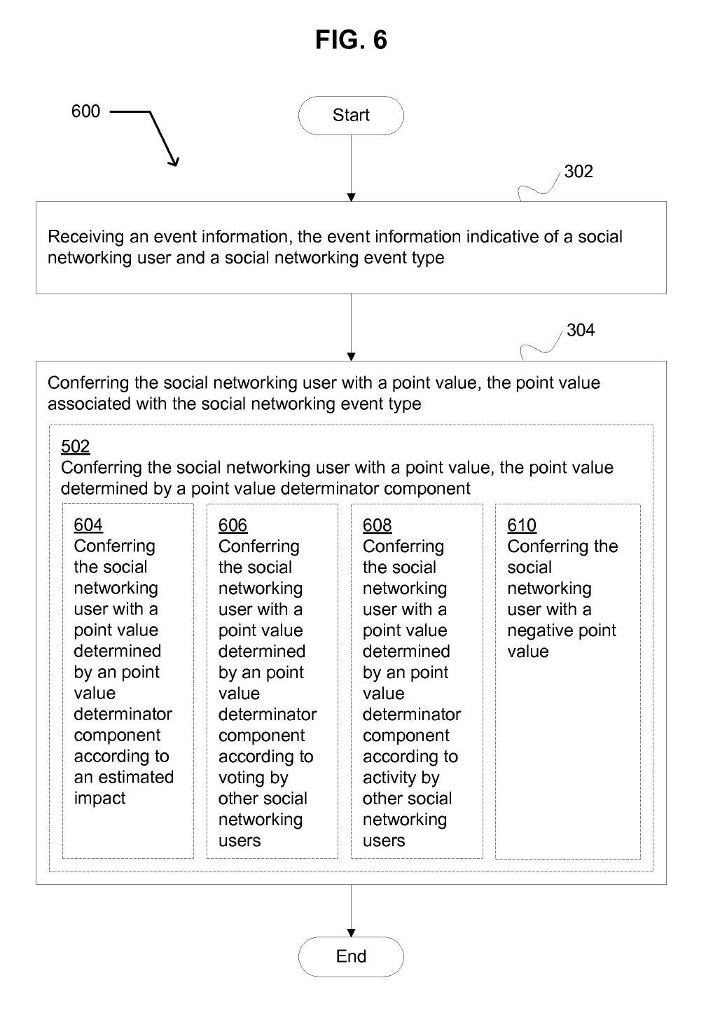

FIG. 6 illustrates alternative embodiments of the example operational flow 300 of FIG. 3. FIG. 6 illustrates example embodiments where the conferring operation 304 and the determining operation 502 may include at least one additional operation. Additional operations may include operation 604, operation 606, operation 608 and/or operation 610.

At the operation 604, the social networking user is conferred with a point value, the point value determined by a point value determinator component according to an estimated impact. For example, when receiving an event information indicative of social networking user 100 performing a social networking activity, the point value determinator component may determine a point value based upon an impact of the activity that is estimated. The estimated impact of a post created by a user may include a particular number of users predicted to comment on the created post. Say, for example, user 100 creates a social networking post. If social networking posts created by user 100 historically attract comments from 3 users, the new post may be associated with 10 points. Or, if social networking posts created by user 100 historically attract comments from 30 users, the new post may be associated with 15 points. Alternatively, if user 100 uploads a video about a non-controversial topic, such as user 100's new lawn mower, the video may be associated with 3 points. However, if user 100 uploads a video about a topic the point value determinator component estimates to be controversial and comment-provoking, such as by comparing a video description written by the user with a topical search, the video may be associated with 30 points.

At the operation 606, the social networking user is conferred with a point value, the point value determined by a point value determinator component according to voting by other social networking users. For example, when a social networking user 100 posts a picture, the social network 120 may establish a voting scheme by which other social networking users 102 up to 10N may vote on the picture posted by user 100. The point value determinator component may take voting into account when determining a point value to confer on social networking user 100 for the picture.

At the operation 608, the social networking user is conferred with a point value, the point value determined by a point value determinator component according to activity by other social networking users. For example, when a social networking user 100 posts a link or otherwise shares content with other social networking users, the other social networking users may repost the link or re-share the content. The point value determinator component may confer more points on the social networking user 100 each time an additional social networking user 10N reposts or re-shares the content.

At the operation 610, the social networking user is conferred with a negative point value. For example, when a social networking user 100 blocks another social networking 102, such that the activity of social networking user 102 is no longer visible to social networking user 100, the point value determinator component may confer a negative point value on at least one of social networking user 100 and/or social networking user 102.

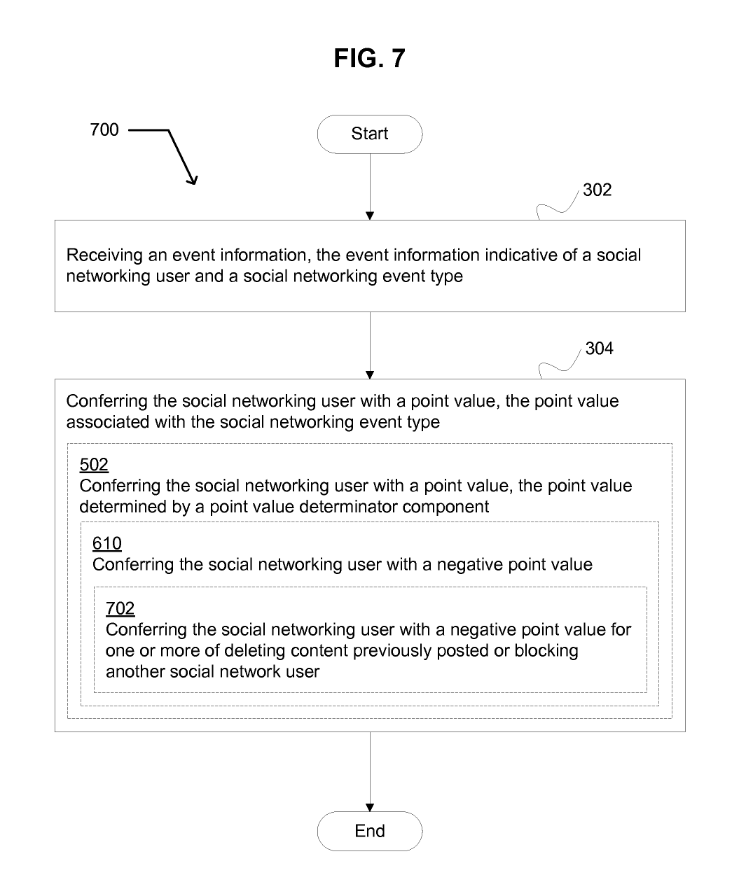

FIG. 7 illustrates an alternative embodiment of the example operational flow 300 of FIG. 3. FIG. 7 illustrates an example embodiment where the conferring operation 304, the determining operation 502 and the conferring operation 610 may include at least one additional operation. The additional operation may be operation 702. At the operation 702, the social networking user is conferred with a negative point value for one or more of deleting content previously posted or blocking another social networking user. For example, the social networking user 100 may delete content from the user's profile that the user previously posted. In some embodiments, the user 100 may have been conferred points associated with the posting of content. At operation 702, the user 100 may be conferred with a negative point value associated with the removal of the same content. It will be understood that a variety of social networking content events exist, with a partial listing of such events being included elsewhere herein, and that any such social networking content event that is received may be associated with a negative point value consistent with the context of the instant disclosure.

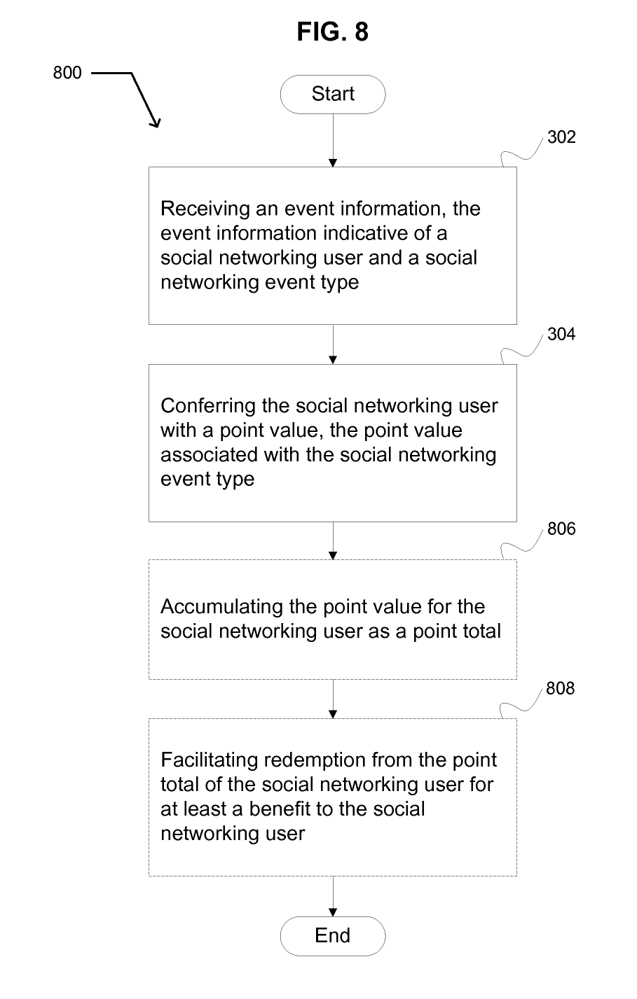

FIG. 8 illustrates alternative embodiments of the example operation flow 300 of FIG. 3. FIG. 8 illustrates example embodiments where the operational flow may have at least additional operation 806 and may further have additional operation 808.

At operation 806, the point value is accumulated for the social networking user as a point total. For example, when a social networking user 100 creates a new status update on the social network 102, the point value with which the social networking user 100 was conferred at operation 304 will be accumulated with point values previously conferred on the social networking user. In this manner, the social networking user accumulates both positive and negative point values associated with particular social networking event types as a point total.

At operation 808, a facilitating operation takes place, in which redemption of at least a portion of the point total of the social networking user is facilitated for at least a benefit to the social networking user. For example, at operation 808, redemption of 1000 points accumulated by the social networking user 100 in exchange for an airline ticket is facilitated. The benefit to the social networking user for which points may be redeemed may include cash, merchandise, services, travel, credits for future system usage, credits for future usage of a different system, or anything which may have value to a social networking user.

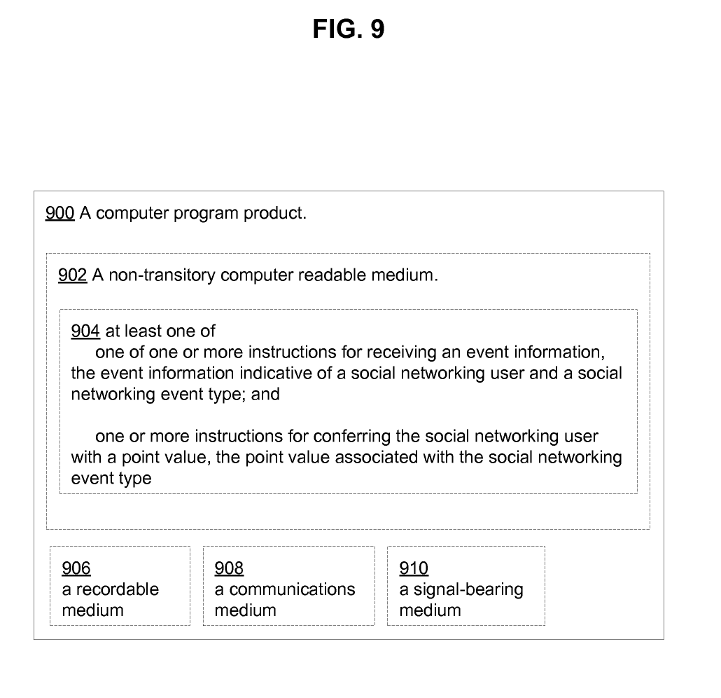

FIG. 9 illustrates a partial view of an exemplary computer program product 900 that includes a computer program 904 for executing a computer process on a computing device. An embodiment of the exemplary computer program product 900 is provided using a non-transitory computer readable medium 902, and may include at least one of one or more instructions for receiving an event information, the event information indicative of a social networking user and a social networking event type; and one or more instructions for conferring the social networking user with a point value, the point value associated with the social networking event type. The one or more instructions may be, for example, computer executable and/or logic-implemented instructions. In one implementation, the non-transitory computer readable medium 902 may include a recordable medium 906. In one implementation, the non-transitory computer readable medium 902 may include a communications medium 908. In one implementation, the non-transitory computer readable medium 902 may include a signal-bearing medium 910.

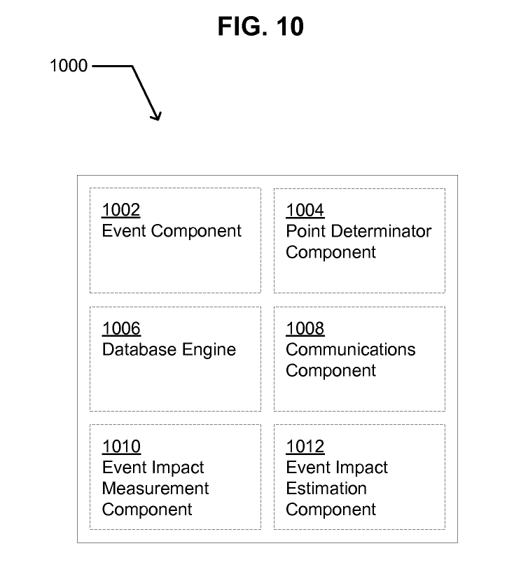

FIG. 10 presents a block diagram of an exemplary environment in which the methods and systems described herein may operate. In some embodiments, a rewards server 122 and/or a rewards server 202 may be implemented as a system 1000. In some embodiments, system 1000 may have an event component 1002, the event component adapted for at least receiving event information indicative of a social networking user and a social networking event type. In some embodiments, system 1000 may have a point determinator component 1004, the point determinator component being configured for at least determining a point value to confer upon a social networking user associated with a particular social networking event type.

In some embodiments, system 1000 may have a database engine 1006, the database engine providing at least storage, storage routines, and other such functions for at least event information, points, and other data and structures as described more fully elsewhere herein. In some embodiments, system 1000 may have a communication component 1008, the communications component configured to at least receive information from a social network server 120.

In some embodiments, system 1000 may have an event impact measurement component 1010, the event impact measurement component configured to at least measure the impact of one or more of a social networking activity and/or a social networking user. In some embodiments, system 1000 may have an event impact estimation component 1012, the event impact measurement component configured to at least estimate the impact of one or more of a social networking activity and/or a social networking user.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method of rewarding social networking users, comprising:
receiving an event information, the event information indicative of a social networking user and a social networking event type; and
conferring the social networking user with a point value, the point value associated with the social networking event type;
wherein at least one of the receiving or conferring is at least partially implemented in hardware.

2. The method of claim 1, wherein the receiving an event information, the event information indicative of a social networking user and a social networking event type comprises:
receiving an event information from a social networking system.

3. The method of claim 2, wherein the receiving an event information from a social networking system comprises:
receiving an event information from a social networking system that is external.

4. The method of claim 1, wherein the receiving an event information, the event information indicative of a social networking user and a social networking event type comprises:
receiving event information indicative of at least one of a user event type or a content event type.

5. The method of claim 4, wherein the receiving event information indicative of at least one of a user event type or a content event type comprises:
receiving event information indicative of a user event type, the user event type comprising one or more of signing up for the social network, adding another social network user to a friends list or blocking another social network user.

6. The method of claim 4, wherein the receiving information indicative of at least one of a user event type or a content event type comprises:
receiving event information indicative of a content event type, the content event type comprising one or more of posting an image, posting a status update, writing on a wall of another social network user, commenting on content posted by another social network user, or deleting content previously posted.

7. The method of claim 1, wherein the conferring the social networking user with a point value, the point value associated with the social networking event type comprises:
conferring the social networking user with a point value, the point value determined by a point value determinator component.

8. The method of claim 7, wherein the conferring the social networking user with a point value, the point value determined by a point value determinator component comprises:
conferring the social networking user with a point value determined by an point value determinator component immediately upon receiving an event information.

9. The method of claim 7, wherein the conferring the social networking user with a point value, the point value determined by a point value determinator component comprises:
conferring the social networking user with a point value determined by an point value determinator component at a future time after receiving an event information.

10. The method of claim 7, wherein the conferring the social networking user with a point value, the point value determined by a point value determinator component comprises:
conferring the social networking user with a point value determined by an point value determinator component according to a hierarchy.

11. The method of claim 7, wherein the conferring the social networking user with a point value, the point value determined by a point value determinator component comprises:
conferring the social networking user with a point value determined by an point value determinator component according to a measured impact.

12. The method of claim 7, wherein the conferring the social networking user with a point value, the point value determined by a point value determinator component comprises:
conferring the social networking user with a point value determined by an point value determinator component according to an estimated impact.

13. The method of claim 7, wherein the conferring the social networking user with a point value, the point value determined by a point value determinator component comprises:
conferring the social networking user with a point value determined by an point value determinator component according to voting by other social networking users.

14. The method of claim 7, wherein the conferring the social networking user with a point value, the point value determined by a point value determinator component comprises:
conferring the social networking user with a point value determined by an point value determinator component according to activity by other social networking users.

15. The method of claim 7, wherein the conferring the social networking user with a point value, the point value determined by a point value determinator component comprises:
conferring the social networking user with a negative point value.

16. The method of claim 15, wherein the conferring the social networking user with a negative point value comprises:
conferring the social networking user with a negative point value for one or more of deleting content previously posted or blocking another social network user.

17. The method of claim 1, comprising:
accumulating the point value for the social networking user as a point total.

18. The method of claim 17, comprising:
facilitating redemption from the point total of the social networking user for at least a benefit to the social networking user.

19. A computer program product encoded in a non-transitory computer readable media, the computer program product bearing instructions for:
receiving an event information, the event information indicative of a social networking user and a social networking event type; and
conferring the social networking user with a point value, the point value associated with the social networking event type.

20. A system comprising:
means for receiving an event information, the event information indicative of a social networking user and a social networking event type; and
means for conferring the social networking user with a point value, the point value associated with the social networking event type.
